(19) United States
(12) Patent Application Publication
(10) Pub. No.: US 2004/0187382 A1
(43) Pub. Date: Sep. 30, 2004

(54) Foldable vase

(76) Inventor: Haven Kam-Chuen Tsang, Hong Kong (CN)

Correspondence Address: Charles I. Brodsky, Esq., 2 Bucks Lane, Marlboro, NJ, 07746, US

(21) Appl. No.: 10/395,598

(22) Filed: Mar. 25, 2003

(51) Int. Cl. A01G 5/00; A47G 7/00

(52) U.S. Cl. 47/41.01

(57) ABSTRACT

A foldable vase having upper and base portions of such plastic film layers as polyvinylchloride spreadably openable from an initial flat configuration upon immersion in warm water, and hardenable to a predetermined shape when thereafter filled with cold water.

### CROSS-REFERENCE TO RELATED APPLICATIONS

NONE

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to vases, in general, and to those utilized in the display of one or more flowers in arrangement, in particular.

2. Description of the Related Art

As will be understood, a recipient of a floral bouquet as a gift often lacks a proper vase to display it to its utmost; even if a vase were possessed, it might be of insufficient height for the arrangement (leading to the cutting of long-stemmed roses, for example), or of too much height (in which case an excess amount of water would need to be added to reach its stems). While an obvious solution would be for the giver of such bouquet to present an adequate vase at the same time, experience shows that that is just not the case. But, even if one were given, then the recipient would have to make arrangements to store the vase after the flowers had died, and the water poured out. Additionally, if the floral bouquet were of a type that was purchased in a display section at a supermarket, for example—instead of at a florist—a situation might very well arise where the cost of the vase would be greater than that for the bouquet sold alongside, possibly dissuading the purchase to begin with by one of limited means.

As will be seen from the description that follows, the present invention is of a foldable vase which is inexpensive, which can lie flat when not needed, and which is easily openable to receive either a single flower or a bouquet in just a matter of seconds. As will also be seen, once the flowers die, and the water poured out, the vase can be restored just as easily to its flattened state, to be stored away when needed once again. And, because of its inexpensive cost—available at prices less than $2.00—the vase is easily affordable even if it is expected to be discarded when the flowers die.

### SUMMARY OF THE INVENTION

As will become clear from the following description, the foldable vase of the invention comprises an upper portion and a base portion, each composed of plastic film layers of preselected hardness and thickness which are spreadable open from an initial flat configuration upon immersion in warm to hot water—or, for example, by running it under warm to hot tap water to soften the layers in anywhere from 15-45 seconds, depending upon water temperature. Filling the spread-open layers with warm to cold tap water then shapes the vase, while discarding that water and filling it again with cold water hardens the vase to stabilize its shape—all, in manners of a few seconds each. Once the water is emptied after the floral arrangement has died or is otherwise thrown away, running the vase under warm tap water softens the film layers so that they can be flattened again to their original flat condition.

In a preferred embodiment of the invention, the plastic film layers are selected of a 24 phr-28 phr hardness range polyvinylchloride so that the plastic will shape up when warmed and hard enough to stand by itself when cooled down, even when filled with water. A thickness range of between 0.2 mm and 0.35 mm facilitates this preferred reflattenable folded use construction. In configuring the vase of a composition to make it as safe as possible for the flower bouquet, the lowest toxicity standard DINP is selected for the polyvinylchloride film—although the openability of the vase and its later flattenability when run under, or reimmersed in warm water will result for higher toxicity standard plastics as well.

### BRIEF DESCRIPTION OF THE DRAWINGS

These and other features of the present invention will be more clearly understood from a consideration of the following description, taken in connection with the accompanying Drawings, in which:

FIGS. 1a and 1b are front and right side views of a foldable vase embodying the invention when closed flat, a left side view being a mirror image of the right side view;

FIGS. 2a-2e are illustrations helpful in an understanding of a preferred manufacture for the foldable vase of FIGS. 1a and 1b; and

FIG. 3 is a pictorial view of the foldable vase of the invention spread open to its stabilized shape after first being softened by immersion in warm water (or exposed to a warm liquid solution) and thereafter filled with cold water (or a cold liquid solution).

### DETAILED DESCRIPTION OF THE INVENTION

While the teachings of the present invention apply equally as well when the foldable vase construction is immersed in a warm water or warm liquid solution and thereafter filled with a cold water or cold liquid solution, the following description assumes that the softening of the plastic film layers follows from a running under warm tap water, and a filling (once stretched open) from a cold water tap; the principles and operation result equally as well, with the lengths of time required for “softening” and for “setting” depending only on the temperatures of the water or solutions used to bring the vase from its flat open condition as stored to the spread condition, as assembled.

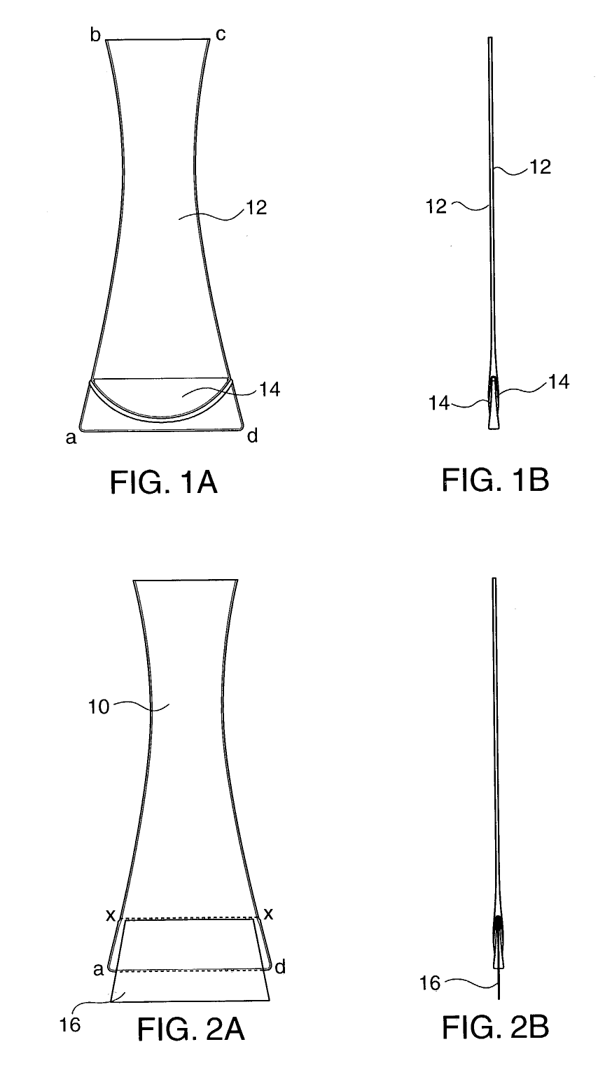

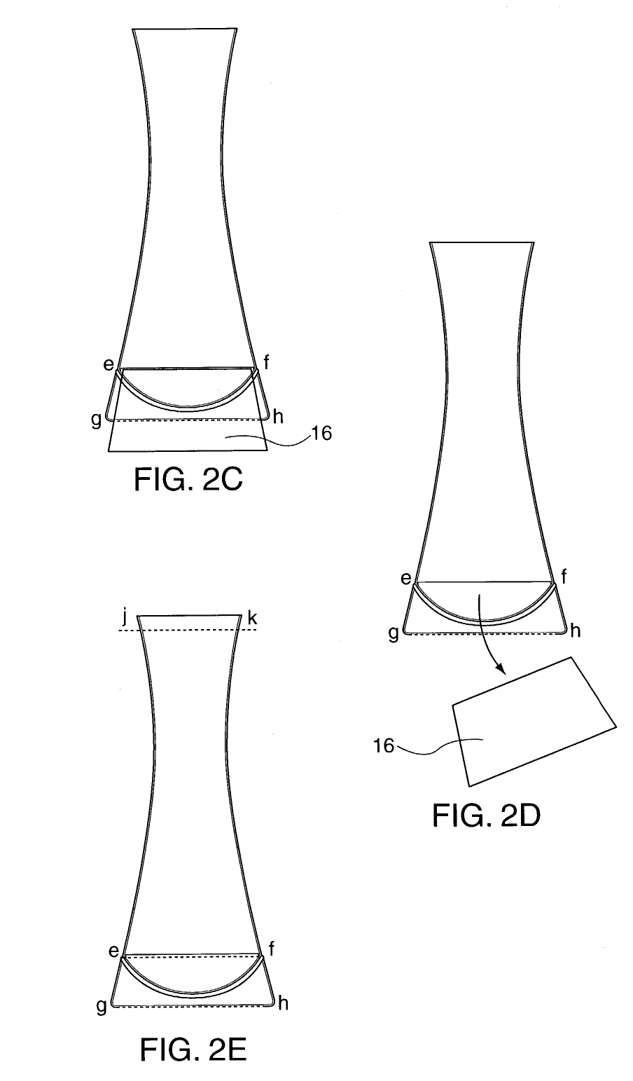

Thus, referring to the Drawings, the foldable vase 10 includes a first pair of plastic front and rear film layers 12 and a second pair of plastic front and rear film layers 14—with the film layers 12 being of substantially identical configuration and composition (such as polyvinylchloride), and with the film layers 14 likewise being of substantially identical configuration and composition (i.e., polyvinylchloride as well). As shown in FIG. 1b, the film layers 14 are inserted between the film layers 12, in forming a 4-layer arrangement to serve as a base for the foldable vase 10. In a first manufacturing step, the front and rear film layers 12 are bonded together along the vertical line “ab” and along the vertical line “cd” (FIG. 1a). Such bonding may be done in a first mold. The two layers 12 and the two layers 14 are then bonded at their side edges along the lines “ax” and “dx” in a second mold (FIG. 2a). A plastic film insert 16 is then inserted between the two layers 14 within the second mold, with the insert being heat resistant, high frequency oscillation transmittable, and of a characteristic so as not to bond with the plastic film layers during this manufacturing step. An insert—of the order of 0.1 mm thick—serves as a removable cushion for further bonding processes in providing a gap which remains after the film insert 16 is removed. The front view of FIG. 2a and the side view of FIG. 2b illustrate the insert 16 in position.

With the film insert 16 in place, the four plastic film layers are then bonded together in the second mold along the lines “ef” and “gh” (FIG. 2c)—with the front and rear film layers 12 being sealed together along the line “ef” and with the film layers 12 and 14 being sealed together both in the front and in the rear along the line “gh”. In this respect, the plastic insert 16 forces the film layers 14 upwardly so that the bonding of the film layers 14 to either side of the film layers 12 takes place along the curvilinear line “ef”. The plastic film insert 16 is then removed (FIG. 2d), and the top of the layers 12 are then cut along the line “jk” (FIG. 2e).

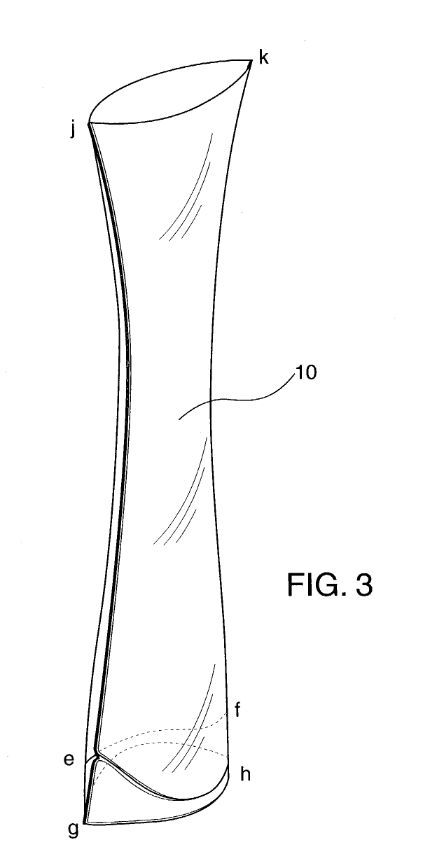

Immersing the vase of FIG. 2e in warm to hot water, or running it under a hot water tap, then softens the plastic film layers so that the film layers 12 can be spread apart along the line “ef”. Filling the open top with warm to cold tap water along the line “jk” shapes the vase; discarding that water and replacing it with cold tap water then stabilizes the shape. The vase can then be placed on a table, stand or otherwise (FIG. 3), to remain stable on its front and rear base lines “gh” which are curved open by the spreading of the film layers 12. As will be appreciated, employing curved lines for the lines “gh” rather than straight lines reduces any tendency for the standing vase to wobble.

The end result will be seen to be a flexible vase having an upper section and a base section, each composed of two layers of plastic film of preselected hardness and thickness. An upper section composed of the two film layers 12 and a base section composed of the two film layers 14—each of 24-28 phr hardness and each of 0.2 mm and 0.35 mm thickness—is preferable, of the lowest toxicity standard DINP, although higher toxicity standards could be employed as well. The upper section consists of the front and back layers 12 while the base section consists of the intermediate layers 14 bonded to the front and back layers along the curvilinear line “ef” and folded up to the “dashed” horizontal line “ef” by the lifting force of the plastic insert 16. In this respect, the curvilinear line “ef” compensates the distortion produced by the base line “gh” when the foldable vase 10 is opened, thereby providing an even resting edge when the vase is placed on a hard flat surface.

After the floral bouquet added to the vase of FIG. 3 dies and is discarded, and the water therein poured out, the foldable vase 10 can once again be run under warm or hot water, and pressed back to its initial flat configuration. At that time, the flattened vase can be stored for reuse, or simply thrown away. In those instances in which it may be desired to design or color the vase, such process can be carried out before the top opening is cut along the line “jk” so as to keep any dye particulate matter away from the inner part of the vase. As heating the vase softens it, low temperature dispersion dies are preferable for such coloration process. Afterwards, the top opening of the vase can be cut along the line “jk” for the vase then to be used. As will be seen, the bottom half of the vase when opened is of a trapezoidal shape on two of its sides.

While there have been described what are considered to be preferred embodiments of the present invention, it will be readily appreciated by those skilled in the art that modifications can be made without departing from the scope of the teachings herein. Thus, whereas polyvinylchloride film layers are to be preferred in the foldable vase construction, other plastic film layers could be employed instead, although they may not be of an optimum hardness characteristic nor of a transparency to give the appearance of glass more nearly possible with polyvinylchloride film. Similarly, film thicknesses beyond 0.35 mm could be used for larger size vases (for example, up to 0.5 mm), especially where they are to stand longer and where reflattening for re-use is less important, although increasing the thickness makes the vase more costly to manufacture, and more difficult to manage in terms of opening and re-opening the vase. And, as will be appreciated, exactly what toxicity standard is selected for the films emplopyed depends ultimately on the use to which the vase is being put—as where the foldable vase is planned for displaying such decorative materials as artificial flowers or colored-sand instead, a lower standard could be employed. For at least such reasons, therefore, resort should be had to the claims appended hereto for a true understanding of the scope of the invention.

I claim:

1. A foldable vase comprising an upper portion and a base portion, each composed of plastic film layers of preselected hardness and thickness spreadably openable from an initial configuration upon immersion in warm liquid solution and hardenable to a predetermined shape when thereafter filled with a cold liquid solution.

2. The foldable vase of claim 1 comprising an upper portion and a base portion of plastic film layers, spreadably openable upon immersion in warm water and hardenable to a predetermined shape when thereafter filled with cold water.

3. The foldable vase of claim 2 wherein said upper and base portions are flattenably spreadable toward said initial configuration when emptied of said cold water and re-immersed in warm water.

4. The foldable vase of claim 3 wherein said upper portion and said base portion are spreadably openable from an initial flat configuration and flattenably spreadable toward said initial flat configuration when re-immersed in warm water.

5. The foldable vase of claim 2 wherein said plastic film layers exhibit a hardness characteristic in the range 24-28 phr.

6. The foldable vase of claim 2 wherein said plastic film layers are of a thickness in the range 0.2 mm-0.50 mm.

7. The foldable vase of claim 2 wherein said plastic film layers exhibit a hardness characteristic of 24 phr-28 phr, and are of a thickness in the range 0.2 mm-0.35 mm.

8. The foldable vase of claim 2 wherein said plastic film layers are of a DINP toxicity standard.

9. The foldable vase of claim 1 wherein said film layers are of a polyvinylchloride plastic composition.

10. A foldable vase comprising:
an upper section and a base section, each composed of a pair of polyvinylchloride film layers of preselected hardness and thickness;
said upper section including first and second film layers and said base section including third and fourth film layers inserted between said first and second film layers;
with opposing side edges of said second and third film layers being bonded with opposing side portion of said first and second film layers;
with a bottom edge of said first film layer bonded with a bottom edge of said third film layer;
with a bottom edge of said second film layer bonded with a bottom edge of said fourth film layer;
with top edges of said third and fourth film layers being bonded together and across said first and second film layers at a first location above said bottom edges of said first and second film layers; and
with an absence of bonding between top edges of said first and second film layers.

11. The foldable vase of claim 10, with intermediate edges of said third and fourth film layers being respectively bonded with said first and second film layers at a second location above said bottom edge of said first and second film layers and below said first location.

12. The foldable vase of claim 10 wherein said intermediate edges of said third and fourth film layers are bonded together in the configuration of overlapping curvilinear lines.

13. The foldable vase of claim 12 wherein said overlapping curvilinear lines downwardly extend from said first and second film layers toward said bottom edges thereof.

14. The foldable vase of claim 11, with said intermediate edges being bonded in the configuration of overlapping curvilinear lines downwardly extending from said first and second film layers toward said bottom edges thereof.

15. The foldable vase of claim 10 wherein said polyvinylchloride film layers exhibit a hardness characteristic within the range 24 phr-28 phr.

16. The foldable vase of claim 10 wherein said polyvinylchloride film layer thickness is in the range 0.2 mm-0.50 mm.

17. The foldable vase of claim 10 wherein said polyvinylchloride film layers exhibit a hardness characteristic within the range 24 phr-28 phr and a thickness in the range 0.2 mm-0.35 mm.

18. The foldable vase of claim 17 wherein said polyvinylchloride film layers are of a DINP toxicity standard.
